(19) United States
(12) Patent Application Publication
(10) Pub. No.: US 2006/0055983 A1
(43) Pub. Date: Mar. 16, 2006

(54) Image forming apparatus, image forming method and program thereof

(75) Inventors: Atsushi Suzuki, Tokyo (JP); Tatsuya Kanazawa, Osaka (JP); Shinji Harada, Osaka (JP); Yuta Miyagawa, Osaka (JP); Noriaki Matsubara, Osaka (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Photo Imaging, Inc., Tokyo (JP)

(21) Appl. No.: 11/220,471

(22) Filed: Sep. 7, 2005

(30) Foreign Application Priority Data
Sep. 13, 2004 (JP) JP2004-265469

(51) Int. Cl. H04N 1/23

(52) U.S. Cl. 358/302

(57) ABSTRACT

An image forming method of making the process from the start to the end of a recording a line for one pixel in recording means as one drive by staggering the drive start timing of each drive section by a predetermined period of time, wherein the recording means comprises an array in which a plurality of chips having a plurality of recording elements are aligned with a plurality of the drive sections for driving the plurality of recording elements provided therein, when an image is recorded on a recording material moving in comparison to the recording means.

### FIELD OF THE INVENTION

The present invention relates to an image forming apparatus for forming an image on a recording material, an image forming method and a program thereof.

### DESCRIPTION OF THE RELATED ART

Heretofore, as the exposure method of forming an image on a silver halide photographic material, there has been known a method of exposing, for example, using a printer head in which optical shutters comprising PLZT (Plomb Lanthanum Zirconate Titanate) elements are arranged in an array-form, by providing an on/off control of the optical shutters pixel by pixel.

The optical shutter comprising the PLZT element may sometimes vary in a light transmission property-due to the influence of residual electrolyte, causing exposure volume fluctuation and resulting in image density variation. As the method of improving the image quality of an image recorded by the print head, disclosed in Japanese Patent Publication Laid-Open No. 2000-347150 is a method of avoiding the phenomenon of photoelectric induced birefringence to control the variation of light transmission property by blinking a light source and irradiating onto the PLZT elements during a standby state of the recording operation.

However, it was proved that in the case where the exposure was carried out by the head using the PLZT optical shutter array, the image density varied when the recording density varied even in the exposure of image data with the same density. More specifically, for example, when the image recording is carried out by feeding a recording material in a direction perpendicular to the array direction of the PLZT elements, the color density of a line image formed by driving all of the PLZT elements and the color density of an intermittent image formed by driving 10% of the whole PLZT elements are different from each other, which is recognized as the variation of density.

### SUMMARY OF THE INVENTION

The present inventor thought that because of the structure of the optical shutter array made of the PLZT elements, the larger the number of PLZT elements to be driven was the larger the potential drop became, causing the variation of light transmission property thereby the density varied due to the exposure volume fluctuation, and as a result of the thought, the inventor achieved the present invention by comprising the optical shutter array to have a module composed of a plurality of optical shutter chips, dividing the optical shutter chips by group and providing independent drivers, and standardizing fluctuations in the potential drop due to the number of PLZT elements to be driven to alleviate the variation of density.

The image forming method of the present invention makes the process from the start to the end of a recording one pixel line in recording means as one drive by staggering the drive start timing of each drive section by a predetermined period of time, wherein a recording means comprises an array in which a plurality of chips having a plurality of recording elements are arrayed with a plurality of the drive sections for driving the plurality of recording elements provided therein, when an image is recorded on a recording material moving in comparison to the recording means.

Further, the image forming apparatus of the present invention has recording means comprising an array in which a plurality of chips having a plurality of recording elements are arrayed with a plurality of drive sections for driving the plurality of recording elements provided therein; recording material feeding means for moving a recording material in comparison to the recording means; and drive control means for driving the drive sections, wherein the drive control means provides control of making the process from the start to the end of a recording one pixel line in the recording means as one drive by staggering the drive start timing of each of the drive sections by a predetermined period of time.

Further, the program of the present invention causes a computer to function as a means of making the process from the start to the end of a recording one pixel line in recording means as one drive by staggering the drive start timing of each drive section by a predetermined period of time, wherein the recording means comprises an array in which a plurality of chips having a plurality of recording elements are arrayed with a plurality of the drive sections for driving the plurality of recording elements provided therein, when an image is recorded on a recording material moving in comparison to the recording means.

### BRIEF DESCRIPTION OF THE RELATED ART

Hereinafter preferred embodiments of the present invention will be described in detail with reference to drawings. However, the scope of the invention is not limited by the illustrations. It is to be understood that the present invention is not limited by the specific descriptions that may be used in connection with the preferred embodiments disclosed herein.

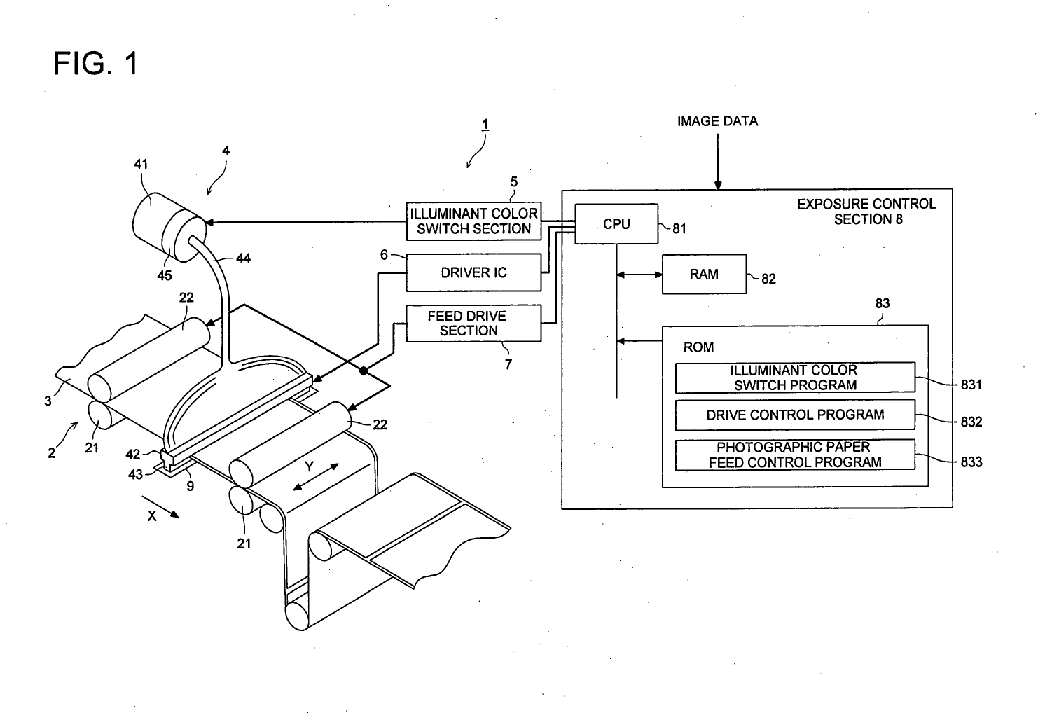

FIG. 1 is a general configuration view of a printer according to an embodiment of the present invention;

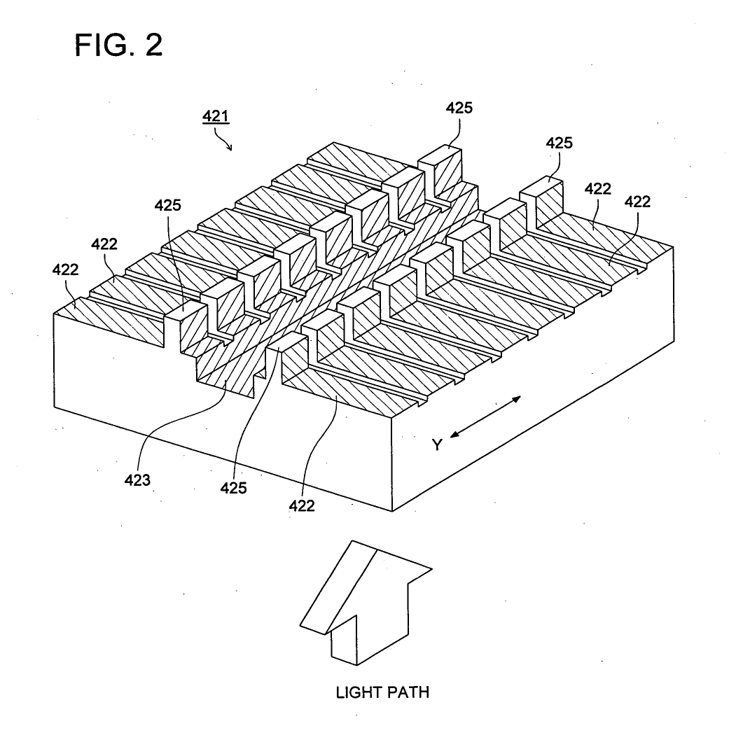

FIG. 2 is a perspective view of a PLZT chip;

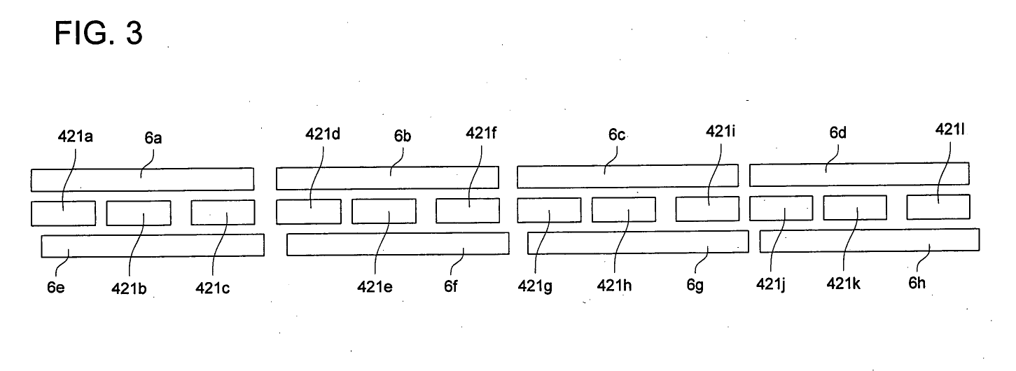

FIG. 3 is a general configuration view of an exposure head;

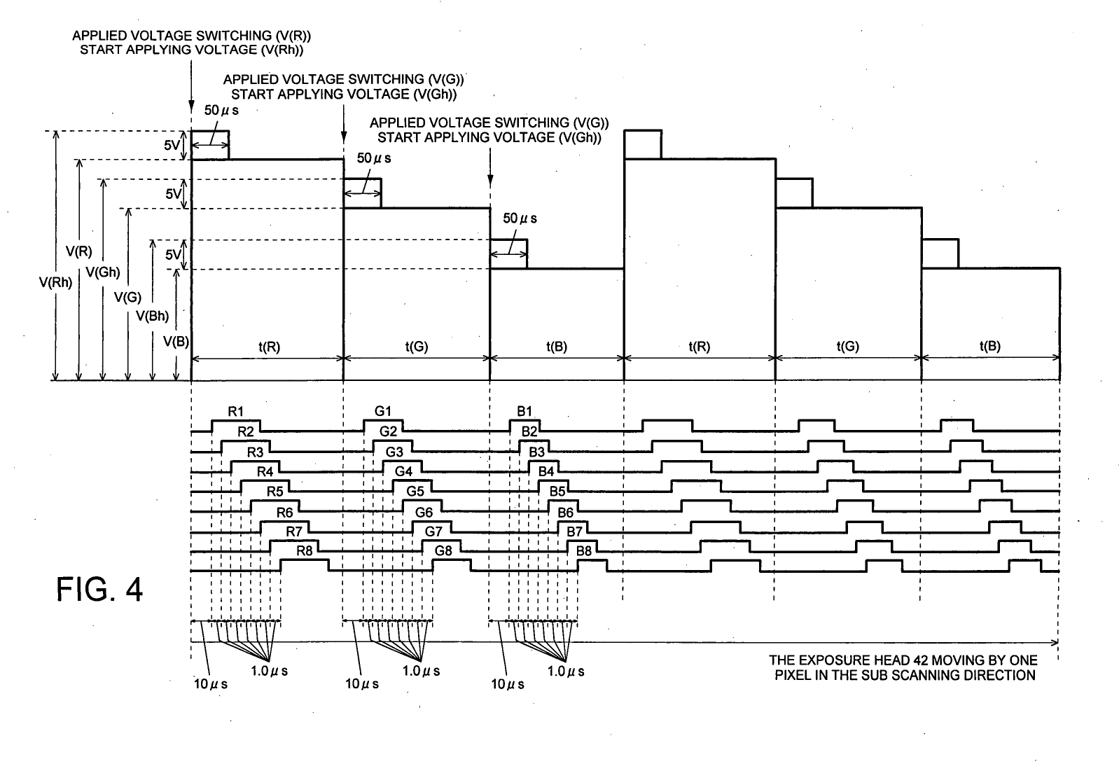

FIG. 4 is a timing chart for illustrating a drive of the exposure head;

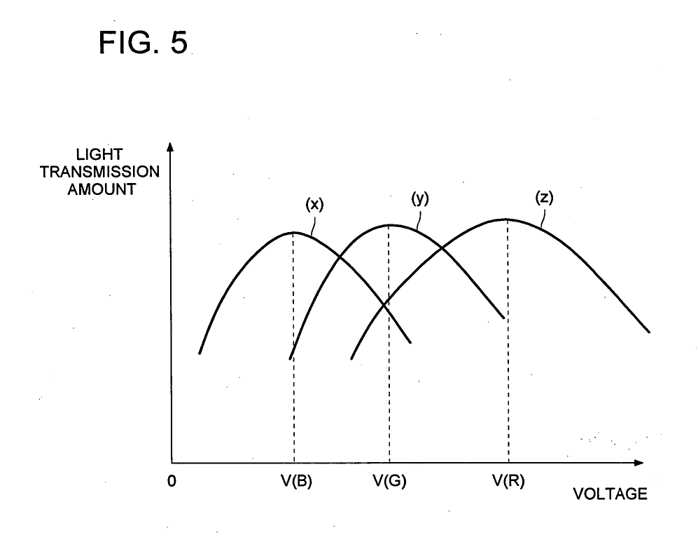

FIG. 5 is a view showing the transmission ratio distributions of illuminant colors in an optical shutter;

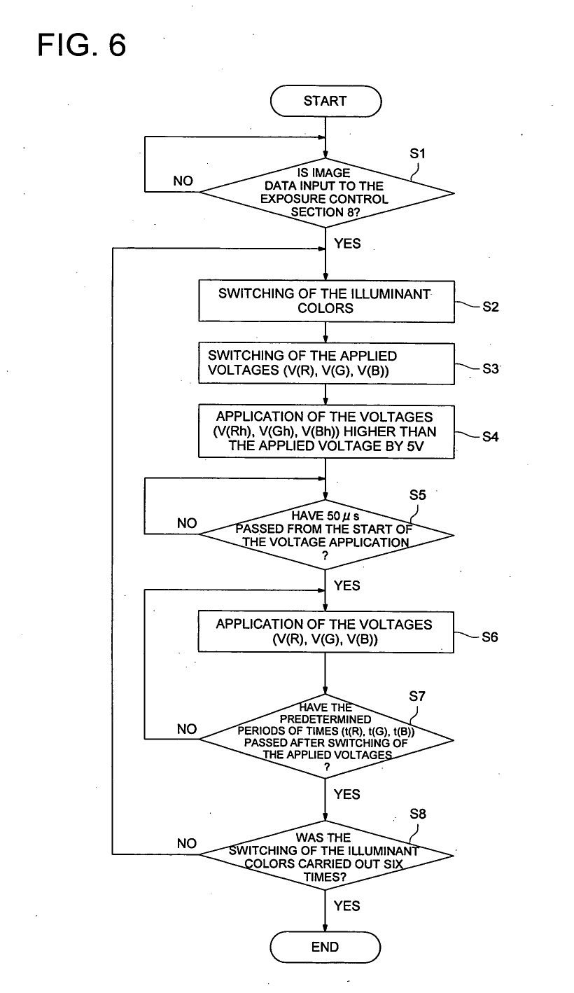

FIG. 6 is a flowchart showing the image forming processing for one line by the printer;

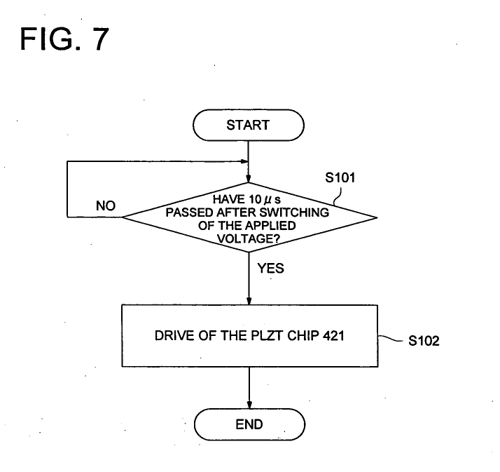

FIG. 7 is a flowchart showing the drive of the exposure head in light source color R;

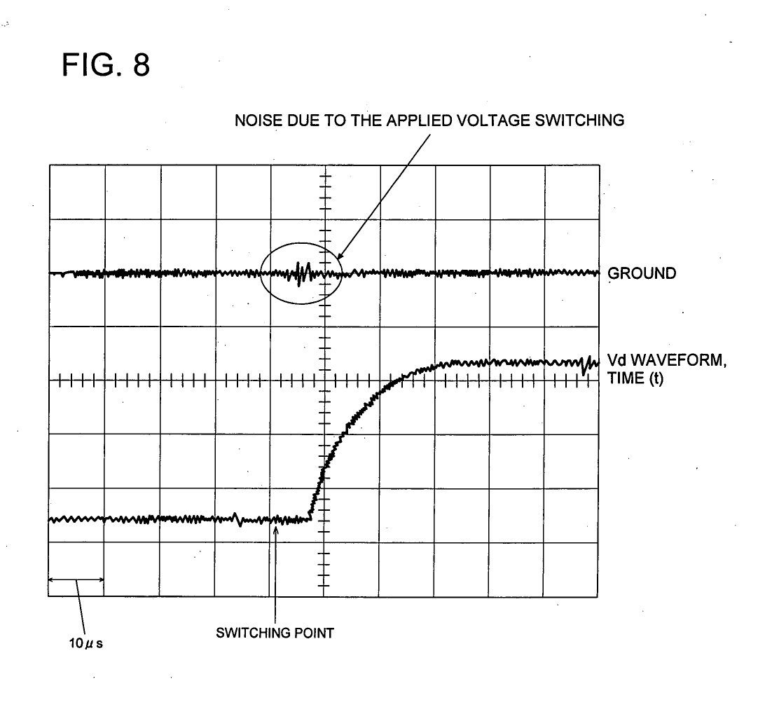

FIG. 8 is a view for illustrating the noise generated in switching of the applied voltage and riding on the ground;

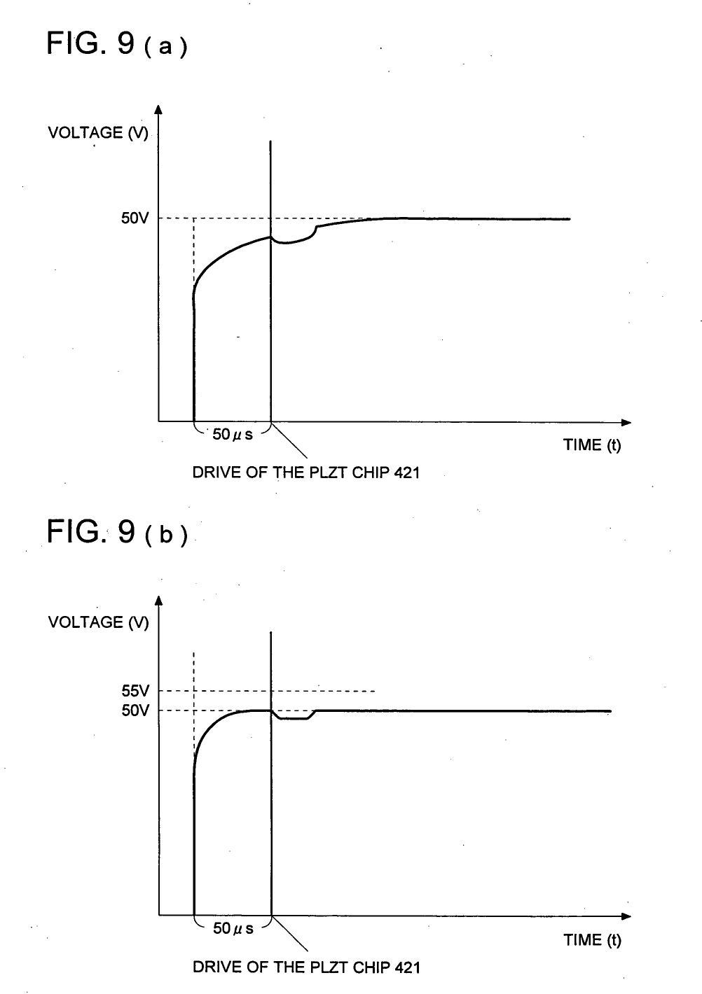

FIG. 9a is a view showing the relation between applied voltage and actually measured voltage when a certain amount of voltage is applied from the start of the voltage application;

FIG. 9b is a view showing the relation between applied voltage and actually measured voltage (the solid line) when a voltage (55 V) higher than the applied voltage is applied for a predetermined period of time from the start of the voltage application;

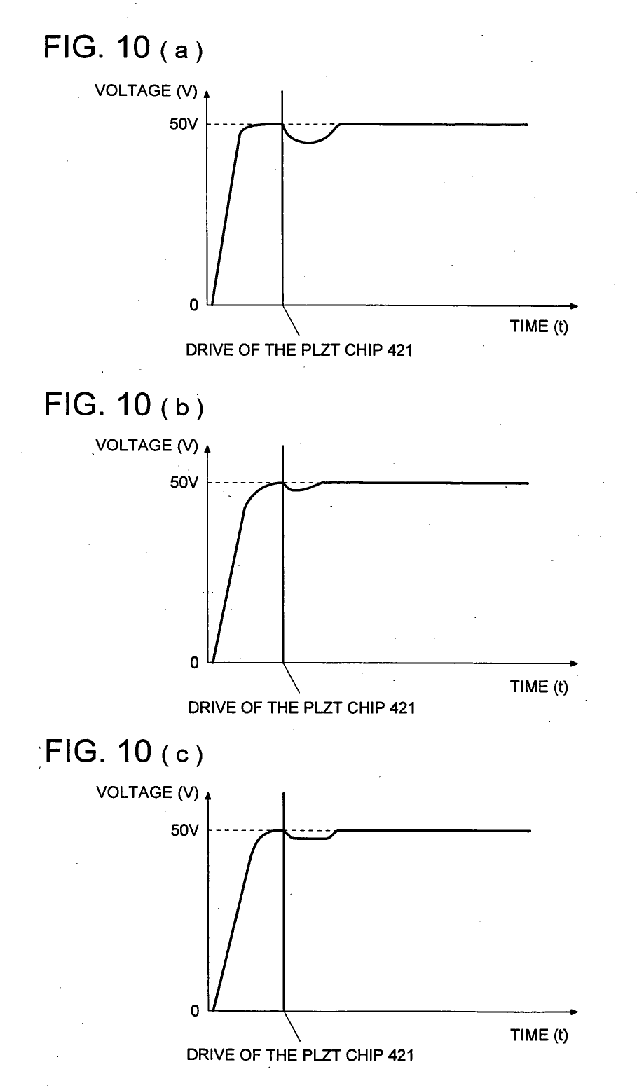

FIG. 10a is a view showing the measured voltage when the drive start timings of all of PLZT chips 421 are identical;

FIG. 10b is a view showing the measured voltage when only one of the PLZT chips 421 is driven; and

FIG. 10c is a view showing the measured voltage when the drive start timing of each of the PLZT chips is staggered by 1.0 μs.

### DESCRIPTION OF THE PREFERRED ENBODIMENT

FIG. 1 is a general configuration view of a 400 dpi photographic digital printer 1 (hereinafter referred to as a “printer”) that applies the present invention. The printer 1 comprises a feeding mechanism 2 for feeding a silver halide photographic material (hereinafter referred to as a “photographic paper”) 3 as a recording material in the X direction as a feeding direction (a sub scanning direction), an exposure mechanism 4 as a recording head for forming an image on the photographic paper 3 in a line-shape along the Y direction which is a direction perpendicular to the X direction (a main scanning direction), an illuminant color switch section 5, a feed drive section 7 for driving the feeding mechanism 2, an exposure control section 8 for controlling a color source switch section 5, a driver IC 6 and the feed drive section 7, and a support member 9 for supporting the photographic paper 3 from underneath in an exposure portion which is exposed in a line-shape by the exposure mechanism 4.

The feeding mechanism 2 comprises drive rollers 21, 21 rotating around an axis perpendicular to the X direction by a power such as a motor and pressure contact rollers 22, 22 pressing and contacting the drive rollers 21 and parallel thereto, wherein either of the drive rollers 21 and either of the pressure contact rollers 22 are disposed in the upstream side in the X direction and the other drive roller 21 and the other pressure contact roller 22 are provided in the downstream side in the X direction. The photographic paper 3 fed from a supply position (not shown) is held between the drive roller 22 and the pressure contact roller 21 and fed in the X direction by the rotation of the drive rollers 21, 21.

In the photographic paper 3, color layers taking colors form a layer structure. From the near surface, the photographic paper 3 has a layer taking cyan when the red light (R) is exposed, a layer taking magenta when the green light (G) is exposed, and a layer taking yellow when blue light (B) is exposed. The photographic paper 3 is wound in a roll at the supply position (not shown).

The exposure mechanism 4 is configured by comprising an LED light source 41 which is a light source comprising the illuminant colors of R (red), G (green), and B (blue), an exposure head 42 placed opposite to the photographic paper 3 between the two drive rollers 21, a selfoc lens array 43 provided between the exposure head 42 and the photographic paper 3, an optical fiber array 44 for guiding light from the LED light source 41 to the exposure head 42, and an integrator 45 lying between an end portion of the optical fiber array 44 and the LED light source 41.

The photographic paper 3 is fed by the feeding mechanism 2 and moves in comparison to the exposure mechanism 4, so that an image corresponding to image data is recorded thereon.

The exposure head 42 as the recording means of the present invention is a PLZT optical shutter array head in which, for example, PLZT (Plomb Lanthanum Ziroconate Titanate) elements as a plurality of recording elements are arranged in an array-form along the Y direction as light output point pixels.

More specifically, the exposure head 42 is the one in which an array is formed with a plurality of PLZT chips 421 comprising a plurality of PLZT elements 425 disposed on a substrate made of ceramic or glass having a slit-like opening and a plurality of driver ICs 6 as the drive sections are aligned in both sides of the plurality of PLZT chips 421.

As shown in FIG. 2, the PLZT chip 421 is three-dimensionally formed and provided with PLZT elements 425, independent electrodes 422, a common electrode 423 and other related components.

For example, a large number of PLZT elements 425 each corresponding to one pixel are arranged in two rows, and each of the PLZT elements 425 is formed in a staggered grid shape pixel by pixel, so that an image of one line is formed in the main scanning direction Y in two rows (an odd row, an even row).

The common electrode 423 is commonly provided in the odd row and the even row, while the independent electrodes 422 which are independent to the odd row and the even row are provided in each of the PLZT elements 425 independently. The both electrodes 422 and 423 are provided in parallel to each other against a light path in both sides of the PLZT elements 425.

The driver ICs 6 vary the applied voltage to be applied to the independent electrodes 422 and the common electrode 423 to drive the PLZT elements 425, namely, the driver ICs 6 are the drive circuits for applying voltage to the PLZT elements 425, driving the PLZT elements 425 in the odd row and the PLZT elements 425 in the even row independently.

The PLZT is, as is well known, a permeable ceramic having a photoelectric effect with large Kerr constant, in which a light that is linear polarized by a polarizer (not shown) generates rotation of a polarization surface by turn-on of the voltage to the PLZT elements 425 by the driver ICs 6 and emitted from an analyzer (not shown). In the voltage-off state, the polarization surface of the transmission light never rotates, and such a transmission light is cut by the analyzer (not shown).

Namely, the on/off of the transmission light is generated by the on/off of the applied voltage to each of the PLZT elements 425, and the light emitted from the analyzer forms an image on the photographic paper 3 via the selfoc lens array 43. The PLZT elements 425 are subjected to an on/off control (a main scanning) line by line based on the image data, and a two-dimensional image is formed on the photographic paper 3 by the main scanning and a movement (a sub scanning) of the photographic paper 3 in the X direction.

FIG. 3 shows a schematic diagram of the exposure head 42 in the embodiment of the present invention. Herein, the exposure head 42 comprises 12 of PLZT chips 421a, 421b, . . . 421l, 8 of the driver ICs 6a, 6b, . . . , 6h and other related components. As shown in FIG. 3, the driver ICs 6 are provided corresponding to the plurality of PLZT chips 421.

The on/off control of the PLZT chips 421 is carried out for each of the driver ICs 6. Therefore, when the driver IC 6a carries out the application of the applied voltage, the PLZT elements 425 in the odd row side of the PLZT chips 421a, 421b, 421c are driven. At the same time, when the driver IC 6e carries out the application of the applied voltage, the PLZT elements 425 in the even row side of the PLZT elements 421a, 421b, 421c also become the state of being driven.

The exposure is carried out during the PLZT elements 425 allow light to pass through, so that the exposure time is controlled depending on the image data to express a tone. For example, shorter exposure time is for expressing lighter density and longer exposure time is for expressing thicker density.

The selfoc lens array 43 is the one in which a plurality of selfoc lenses optically equivalent are integrated in parallel to each other, causing the light having passed through the exposure head 42 to form an image on the photographic paper 3. Namely, an object surface by the selfoc lens array 43 corresponds to the exposure head 42, and a surface with the image formed thereon by the selfoc lens array 43 corresponds to the photographic paper 3. Incidentally, an exposure portion is in a line-shape along the main scanning direction Y on the surface with the image formed thereon by the selfoc lens array 43, and a length of the exposure portion along the main scanning direction Y is practically equal to the length of the alignment of the emission points of the exposure head 42.

Ends of a plurality of optical fibers are bound at an end portion of an optical fiber array 44 which is oriented to the LED light source 41. At the other end portion of the optical fiber array 44, the other end portions of the optical fibers are linked to the PLZT elements 425 which are the optical shutter elements respectively.

The integrator 45 is provided for effectively guiding light from the LED light source 41 to the optical fiber array 44, and dispersing the luminance irregularities of the light source to obtain a uniform illuminance distribution, the integrator 45 comprising, for example, an input lens, a fly-eye lens, an output lens, a filter, and an aperture that are not shown in the figures and other related components.

The illuminant color switch section 5 switches the illuminant colors of RGB (the exposure colors) composing the LED light source 41, for example, in accordance with the on/off instruction from the exposure control section 8 to switch the color of light to be exposed sequentially.

The feed drive section 7 causes the drive rollers 21 to drive to control the feed of the photographic paper 3.

The exposure control section 8 provides synchronized control for the illuminant color switch section 5, the driver ICs 6, and the feed drive section 7, comprising a CPU (Central Processing Unit) 81, an RAM (Random Access Memory) 82, a ROM (Read Only Memory) 83 and the like.

The CPU 81 carries out various types of calculations, instructions to functional sections and transmission of data and other operations based on various types of programs stored in the ROM 83 depending on a predetermined timing and other factors.

The RAM 82 is used for storing the data processed in the CPU 81 and outputting the stored data to the CPU 81 under control of the CPU 81.

The ROM 83 mainly stores programs and data and the like for carrying out various types of operations to be executed in the feeding mechanism 2 and the exposure mechanism 4, more specifically, for example as shown in FIG. 1, storing an illuminant color switch program 831, a drive control program 832, a photographic paper feed control program 833 and other programs.

The illuminant color switch program 831 is a program for carrying out the switching of the illuminant colors RGB twice of the number of the illuminant colors (3) during the recording head 42 moves by one pixel in the sub scanning direction, and the CPU 81 controls the illuminant color switch section 5 by executing the illuminant color switch program 831 to function as the illuminant color switching means.

More specifically, for example, when the switching of the illuminant colors R, G, and B is carried out six times, namely, the switching as the illuminant color RGB is carried out twice, one line is recorded.

When the switching as the illuminant color RGB is carried out twice, for example, assuming that the output value (the depth of the output value) of the output data per pixel is 11 bits (2048 gradations) in the 400 dpi printer 1, the recording by the illuminant color RGB may be practicable in a period of time required for the reproduction of an output value of 10 bits (1024 gradations), so that the simplification of the sequence in the control section may be realized.

The drive control program 832 is a program for driving the exposure head, and the CPU 81 controls the driver ICs 6 by executing the drive control program 832 to function as the drive control means.

The CPU 81 as the drive control means provides control of staggering the drive start timing of each of the driver ICs 6 by a predetermined period of time.

FIG. 4 is a view for illustrating the drive of the exposure head 42 comprising the driver ICs 6 each provided for every three PLZT chips 421 and the drive start timing is divided into eight. Herein, “staggering by a predetermined period of time” specifically means, as shown in R1 through R8 of FIG. 4, the timings to start driving the driver ICs 6, or the PLZT chips 421 are staggered by 1.0 μs respectively. Further, similarly in the illuminant color G and the illuminant color B, as shown in G1 through G8 and B1 through B8 of FIG. 4, the drives of the PLZT chips are started at different timings respectively.

Further, the CPU 81 provides control of switching the applied voltage to be applied to the driver ICs 6 that cause the PLZT chips 421 to drive depending on the illuminant colors of RGB to function as the drive control means.

FIG. 5 shows the transmission ratio distribution of each of the illuminant colors relative to the applied voltage. Reference signs (x), (y), (z) denote the transmission ratio distributions in the wavelength light of 450 nm, the wavelength light of 530 nm, and the wavelength light of 700 nm respectively. Namely, the transmission ratio distribution depends on the emitting wavelength each of the illuminant colors has and the voltage showing the maximum transmission ratio varies. Therefore, different applied voltages are applied depending on the illuminant colors respectively. Herein, when the applied voltages corresponding to the illuminant colors RGB are assumed to be V(R), V(G), V(B) respectively, the relation of the applied voltages is preferably V(R)>V(G)>V(B) as shown in FIG. 5.

Further, as shown in FIG. 4, when assuming the voltage application times in the illuminant colors RGB are t(R), t(G), t(B) respectively, each of the voltage application times is preferably 500 μs or less. Because when exceeding 500 μs, the voltage application time cannot be applicable to high-speed printing.

More specifically, the layer taking yellow when B is exposed has the highest sensitivity, followed by the layer taking magenta when G is exposed, and the layer taking cyan when R is exposed has the lowest sensitivity, so that the exposure time is preferably set to become longer in the order from R, G, and B.

Generally, as the capability required for the photographic exposure devices, the spec of 700 3.5R sheets/hour or more is required. Assuming that the feed length of 3.5R is 89 mm and the paper interval is 20 mm, the writing time for one line at 400 dpi is allowed to be about 3.0 ms. In order to make the resolution of the sub scanning direction 800 dpi, the writing time must be 500 μs or less.

Further, the CPU 81 provides control of starting the drive of each of the PLZT chips 421, for example, 10 μs later when the applied voltage is switched to function as the drive control means.

FIG. 8 is a view showing the noise riding on the ground which is generated in the applied voltage switching and the waveform of Vd (potential) corresponding to the applied voltage switching, wherein the horizontal line indicates the time and the vertical line indicates the voltage. As shown in FIG. 8, the noise disappears after about 10 μs from the applied voltage switching. Accordingly, by separating the applied voltage switching and the drive start timing of the PLZT element chip by 10 μs or more, degradation in picture quality caused by the noise generated in the applied voltage switching can be prevented without fail.

Further, the CPU 81 provides control of applying a voltage higher than the drive applied voltage of the PLZT elements for predetermined period of time from the start of applying the voltage to function as the drive control means.

Herein, a “predetermined period of time” means a period of time for which an appropriate applied voltage can be applied without being influenced by the impedance of the system at the time of starting the drive of each of the PLZT chips 421, for example, 50 μs.

Further, a “voltage higher than the applied voltage” means a voltage which enables the application of an appropriate applied voltage in each of the illuminant colors RGB, for example, a voltage higher than the applied voltage by 5 V.

The photographic paper feed control program 833 is a program for feeding the photographic paper 3, and the CPU 81 controls the photographic paper feed control section 7 by executing the photographic paper feeding control section program 833.

An example of the drive of the exposure head 42 when the printer 1 as described above records an image for one line in accordance with image data will be described using FIG. 4 and the flowcharts shown in FIG. 6.

At first, the CPU 81 judges the existence of input data in the exposure control section 8 (Step S1). When the CPU 81 judges that image data is not input (Step S1; No), the printer 1 becomes the waiting state. When the CPU 81 judges that image data is input in the exposure control section 8 (Step S1; Yes), the CPU 81 selects an illuminant color based on the input image data and carries out the switching operation (Step S2). Data involving the switched illuminant color is stored in the RAM 82. In the embodiment of the preset invention, first switched is R as the illuminant color.

Next, the CPU 81 switches a voltage to be applied to each of the PLZT chips 421 to an applied voltage corresponding to the illuminant color based on the data involving the illuminant color stored in the RAM 82 (Step S3; the drive control process). Namely, as shown in FIG. 4, the CPU 81 switches to voltage V(R) which is the applied voltage corresponding to R.

Next, the CPU 81 starts applying a voltage to the exposure head 42. In this time, the CPU 81 applies a voltage higher than the applied voltage until 50 μs have passed from the start of the voltage application (Step S4; the drive control process). Namely, as shown in FIG. 4, the CPU 81 applies voltage V(Rh) as a voltage higher than the applied voltage V(R) by 5 V.

In Step S5, the CPU 81 judges whether 50 μs have passed from the start of applying the voltage V(Rh) as the voltage higher than the applied voltage (Step S5). When judging that the predetermined period of time has passed (Step S5; Yes), the CPU 81 applies an applied voltage as the applied voltage (V(R)) corresponding to the illuminant color (Step S6). When judging that the predetermined period of time has not passed (Step S5; No), the CPU 81 continues to apply the voltage V(Rh).

Next, the CPU 81 judges whether a predetermined period of time has passed after switching the applied voltage (Step S7). Namely, as shown in FIG. 4, the CPU 81 judges whether t(R) as the predetermined period of time corresponding to the illuminant color has passed or not.

When judging that the predetermined period of time t(R) has passed (Step S7; Yes), the CPU 81 judges whether the switching of the illuminant colors was done six times in total (Step S8; the illuminant color switching process). While, when judging that the predetermined period of time has not passed (Step S7; No), the CPU 81 continues to apply the applied voltage V(R).

In Step S8, when judging that the switching of the illuminant color was not done six times in total (Step S8; No), the CPU 81 moves to Step S2 to execute again the selection and switching of the illuminant color, and continues to execute the processes until Step S8. Namely, as shown in FIG. 6, the CPU 81 executes the processes of Step S2 through Step S8 for the illuminant color G and the illuminant color B.

In Step S8, when judging that the switching of the illuminant color was done six times (Step S8; Yes), the CPU 81 finishes driving the exposure head 42.

Namely, the CPU 81 judges that the switching of the illuminant colors was done six times in total by switching first to R as the illuminant color, and then to G and to B followed by switching again to R and G, B. More specifically, as shown in FIG. 4, when recording an image for one line, the CPU 81 carries out the exposure of each of the illuminant colors RGB repeatedly two times to record the image for one line.

Next, an example of the drive of the exposure head 42 when the image is recorded on the photographic paper 3 by the exposure of the illuminant color R will be described using FIG. 4 and the flowcharts shown in FIG. 7.

At first, the CPU 81 judges whether 10 μs have passed after the applied voltage is switched (Step S101; the drive control process). When judging that 10 μs have passed (Step S101; Yes), the CPU 81 starts driving each of the PLZT chips 421. Herein, as shown in FIG. 4, the CPU 81 causes the driver ICs 6, or the PLZT chips 421 to drive retarding by 1.0 μs respectively (Step S102; the drive control process), and ends the processing.

On the contrarily, in Step S101, when judging that 10 μs have not passed (Step S101; No), the CPU 81 judges again whether 10 μs have passed or not.

The printer 1 as described above, in which the PLZT elements in the recording head 42 are not driven all together but are driven one-by-one and the drive start timing of each of the PLZT elements 421 is staggered, enables suppression of the potential drop variation at the time of starting the drive due to the number of the PLZT elements to be driven, and as a result, an image having less density irregularities and high picture quality can be formed with the variation of the transmission ratio suppressed.

Further, since the drive start timing of each of the PLZT chips 421 is staggered by 1.0 μs or more, the image density irregularities based on the variation of the light transmission ratio due to the potential drop are inferior to the visible level, so that an image with the density irregularities less visible and higher picture quality can be formed.

Generally, the density irregularities caused by such a variation of the light transmission ratio due to the potential drop may easily occur in an image having a large amount of area with certain density such as a design picture, and the density irregularities are not visible in an image with fine gradation. Namely, the image irregularities are disadvantageous in an image in which a certain density area is over a certain range.

Herein, the level of density difference in a visible degree is assumed to be about 0.01 as the density difference. This means a density variation (difference) generated due to the light amount variation of substantial 1.0% in a halftone image with a density about 1.0. In the case in which all of the PLZT elements 421 are caused to emit light, by staggering the drive start timing of each of the PLZT elements 421 by 1.0 μs, the density variation (the light amount variation) compared to that in the case in which one PLZT chip 421 is caused to emit light can be 1.0% or less. Incidentally, in order to make the image higher picture quality, the timing is preferably further staggered. Herein, the light amount variation due to the potential drop of the applied voltage is the largest at the time of starting the drive (emission) of the PLZT elements, so that the lower the tone of the pixel is the more the emission start timing of each of the PLZT chips needs to be staggered.

Further, since the applied voltage varies depending on the illuminant colors RGB, the applied voltage can be optimized for each of the illuminant colors, so that the drive efficiency can be optimized and the high-speed operation can be realized by shortening the period of time required for the record of one line in the sub scanning direction.

Further, the switching of the illuminant color and the drive start of each of the PLZT chips 421 are never carried out at the same time but are carried out with a timing of 10 μs or more therebetween. With this feature, the degradation of the picture quality caused by the noise generated in the applied voltage switching can be prevented without fail.

Further, the voltage to be applied to each of the PLZT chips 421 may be raised to a predetermined voltage before the start of the drive of each of the PLZT chips 421. With this feature, the lowering of the density at the time of starting the drive of each of the PLZT chips 421 can be suppressed, thereby the density irregularities can effectively be prevented.

Further, since the illuminant color is switched at least six times in the range in which the recording for one pixel in the sub scanning direction is carried out, the recording for one pixel is carried out in two separate operations in particular, allowing the reduction of the image displacement in the sub scanning direction generated when the drive start timing of each of the PLZT chips is staggered, thereby enabling the prevention of the image degradation. This is because the color image area covered by a second exposure overlaps to the color image area covered by a first exposure, so that the visual pixel is extended.

Namely, for example, if the printer 1 is a photographic digital printer of 400 dpi or more, the practical image density should be 800 dpi or more, so that the displacement of the pixels generated when each of the PLZT chips 421 is driven with different timing can be 0.0065 mm or less, resulting in the displacement inferior to the visible level.

Further, the used of LED as the light source enables the illuminant colors to be switched, so that the high speed can be realized.

Further, since the period of time for applying the applied voltage is 500 μs or less in each of the illuminant colors RGB, the writing time of one line can be controlled to 3.0 ms or less and the feed speed of the photographic paper 3 can be 22 mm/s or more, so that the printer 1 can be applicable to high-speed printing.

Incidentally, the CPU 81 (the illuminant color switching means) may switch the illuminant color several times for only one of the illuminant colors RGB. In this case, the PLZT elements are driven several times relative to that illuminant color, and the recording for one pixel is carried out in separate operations in particular, allowing the reduction of the displacement of that color image in the sub scanning direction generated because the drive start timing of each of the PLZT chips is staggered, thereby enabling the prevention of the picture quality degradation. As the illuminant color to be switched several times, it is preferable that the illuminant color with the shortest emission time is selected in priority in order to effectively increase the number of times for driving the PLZT elements.

Next, actions according to the present invention will be described with reference to examples.

### EXAMPLE 1

FIG. 9a and FIG. 9b are views showing the relation between the applied voltage having been applied to the driver ICs 6 (the dotted line) and the actually measured voltage (the solid line), wherein the horizontal line indicates the period of time and the vertical line indicates the voltage.

FIG. 9a is the example in the case of applying a certain voltage (50 V) from the start of the application, and FIG. 9b is the example in the case of applying a voltage (55 V) higher than the applied voltage for a predetermined period of time from the start of the application.

In the case of FIG. 9a, it can be seen that the voltage is unstable after the drive start of the PLZT chips due to the influence of the system impedance. Therefore, the adequate voltage cannot be applied to the PLZT elements.

On the other hand, in the case of FIG. 9b, although the voltage temporarily lowers after the drive start of the PLZT chips, the lower width thereof is adequately small as compared to the case of FIG. 9a. Therefore, it is proved that the lower width of the measured voltage of FIG. 9b is smaller as compared to the case of FIG. 9a and substantially necessary voltage is applied.

### EXAMPLE 2

FIGS. 10a through 10c are views showing the measured voltage in the case where the drive start condition of the PLZT chips 421 is varied, wherein the vertical line indicates the voltage and the horizontal line indicates the time. The applied voltage in both of the cases is 50 V.

FIG. 10a shows the measured voltage in the case where the drive start timings of all of the PLZT chips 421 are identical, FIG. 10b shows the measured voltage in the case where only one PLZT chip 421 is driven, and FIG. 10c is the example in the case where all of the PLZT chips 421 are driven with the drive start timings staggered by 1.0 μs respectively.

From FIGS. 10a through 10c, it can be seen that when the drive start timings are staggered by 1.0 μs respectively, the voltage variation is suppressed.

### EXAMPLE 3

The evaluation was made regarding the degree of displacement of two lines with a density of 0.8 and a width of 60 μm aligned in the main scanning direction by varying the spacing between the two lines as shown in Table 1. The evaluation was carried out by 20 examinees based on the reference whether the two lines are visible as two lines or not.

The results are shown in the Table below.

| | Recognition rate relative to |
|---|---|
| | the displacement (%) |
| Spacing (μm) | (Average of 20 examinees) |
| 60 | 100 |
| 50 | 100 |
| 40 | 100 |
| 30 | 100 |
| 20 | 75 |
| 10 | 5 |
| 5 | 0 |

In above Table, the recognition rate relative to the displacement shows of the 20 examinees, how many persons were able to visibly recognize as two lines in percentage (%).

As shown in above Table, when the spacing between the two lines is 10 μm or less, 19 of the 20 examinees were able to visibly recognize as one line. Namely, it was proved that by setting the width between the two lines to 10 μm or less, the two lines were substantially recognized as one line.

When the emission time of 400 dpi pixel is set to 1.0 ms, the emission time of each of the RGB is about 270 μs. For example, the duty rate relative to the maximum emission time of the emission time with a density around 0.8 is about 25%, and the emission start timing can be staggered up to about 200 μs. In this time, the displacement is about 13 μm because the size of one pixel is 64 μm (400 dpi), which will be recognized as displacement from the results of above Table. However, it is possible to practically suppress the displacement to 6.5 μm by setting the resolution to 800 dpi.

Namely, when the illuminant color is switched six times in the range where recording for one pixel is carried out in the sub scanning direction, in the drive of each of the PLZT chips which are started with a predetermined period of time staggered, the displacement on the image can be suppressed inferior to the visible level (6.5 μm) even in the case in which the predetermined period of time is set to a maximum value, so that high picture quality can be realized.

Incidentally, herein a “maximum value”, namely a maximum value of the predetermined period of time is a value determined by the conditions such as the density (the emission time duty), and for example, a 400 dpi photographic digital printer is desired to have a maximum value set such that the displacement on the image is 10 μm or less.

What is claimed is:

1. An image forming method of making the process from the start to the end of a recording a line for one pixel in recording means as one drive by staggering the drive start timing of each drive section by a predetermined period of time,
wherein the recording means comprises an array in which a plurality of chips having a plurality of recording elements are aligned with a plurality of the drive sections for driving the plurality of recording elements provided therein, when an image is recorded on a recording medium moving in comparison to the recording means.

2. The image forming method according to claim 1, wherein said drive sections are that for dividing and driving said chips by group, said predetermined period of time being 1.0 μs or more.

3. The image forming method according to claim 1, wherein said recording elements are PLZT optical shutters.

4. The image forming method according to claim 3, wherein said recording means is equipped with a light source emitting illuminant colors of R (red), G (green), B(blue) and switches an applied voltage given to said drive sections in response to the illuminant color.

5. The image forming method according to claim 4, wherein a recording by said recording means is started after a predetermined period of time when the applied voltage is switched in response to said illuminant color.

6. The image forming method according to claim 5, wherein said predetermined period of time is 10 μs or more.

7. The image forming method according to claim 4, wherein an applied voltage to said drive sections is set through the application of a voltage higher than said applied voltage for a predetermined period of time.

8. The image forming method according to claim 4, wherein a recording with at least one of the illuminant colors is carried out several times in the recording of a line for one pixel.

9. The image forming method according to claim 4, wherein the recording with all of the illuminant colors is carried out the same number of times in the recording of a line for one pixel.

10. The image forming method according to claim 4, wherein said light source is an LED light source.

11. An image forming method of carrying out a recording with at least one illuminant color several times in the recording of a line for one pixel,
in recording means comprising an array in which a plurality of chips having a plurality of recording elements are aligned with a plurality of drive sections for driving the plurality of recording elements provided therein,
when an image is recorded on a recording material moving in comparison to said recording means, wherein said recording means is equipped with a light source emitting illuminant colors of R (red), G (green), B (blue).

12. The image forming method according to claim 11, wherein a recording with all of the illuminant colors is carried out the same number of times in the recording of a line for one pixel.

13. An image forming apparatus comprising:
recording means comprising an array in which a plurality of chips having a plurality of recording elements are aligned with a plurality of drive sections for driving the plurality of recording elements provided therein;
feeding means for moving a recording material in comparison to the recording means; and
drive control means for driving said drive sections,
wherein said drive control means provides control of making the process from the start to the end of a recording a line for one pixel in said recording means as one drive by staggering a drive start timing of each of said drive sections by a predetermined period of time.

14. The image forming apparatus according to claim 13, wherein said drive sections divide and drive said chips by group.

15. The image forming apparatus according to claim 13, wherein said recording elements are PLZT optical shutters.

16. The image forming apparatus according to claim 15, wherein said recording means is equipped with a light source emitting illuminant colors of R (red), G (green), B (blue), said drive control means comprising applied voltage switching means for switching the applied voltage given to said drive sections in response to the illuminant color.

17. The image forming apparatus according to claim 16, comprising illuminant color switching means for switching said illuminant colors.

18. The image forming apparatus according to claim 13, wherein the recording material is a silver halide photographic material and is a digital printer forming a photographic image of 400 dpi or more.

19. The image forming apparatus according to claim 15, wherein said light source is an LED light source.

20. A computer program for causing a computer to function as a means of making the process from the start to the end of a recording a line for one pixel in recording means as one drive by staggering the drive start timing of each drive section by a predetermined period of time,
wherein the recording means comprises an array in which a plurality of chips and having a plurality of recording elements are aligned with a plurality of the drive sections for driving the plurality of recording elements provided
when an image id recorded on a recording material moving in comparison to the recording means.
